(19) United States
(12) Patent Application Publication
(10) Pub. No.: US 2008/0039281 A1
(43) Pub. Date: Feb. 14, 2008

(54) Vehicle And Method For Controlling The Same

(76) Inventors: Koichi Okuda, Susono-shi (JP); Takashi Ohta, Susono-shi (JP); Shuji Nagano, Susono-shi (JP)

Correspondence Address: OLIFF & BERRIDGE, PLC, P.O. BOX 320850, ALEXANDRIA, VA, 22320-4850, US

(21) Appl. No.: 11/791,151

(22) PCT Filed: Dec. 22, 2005
(86) PCT No.: PCT/IB05/03854

§ 371 Date: May 21, 2007

(30) Foreign Application Priority Data
Dec. 27, 2004 (JP) 2004-376907

(51) Int. Cl. B60W 10/00

(52) U.S. Cl. 477/73

(57) ABSTRACT

Whether the master cylinder pressure Pm of the brake master cylinder is higher than the reference pressure Pmref is determined (step S 120). Based on the determination, the lock-up clutch of the torque converter is promptly released (step S130) or gradually released (step S140). Whether the master cylinder pressure Pm is higher than the reference pressure Pmref is determined (step S160). Based on the determination, the connection provided by the clutch is promptly terminated (step S170), or gradually terminated (step S180). Because the lock-up clutch is released and the connection provided by the clutch is terminated based on the operation of the brake pedal performed by the driver, a sense of discomfort felt by the driver can be suppressed.

### BACKGROUND OF THE INVENTION

1. Field of the Invention

The invention relates to a vehicle and a method for controlling the same.

2. Description of the Related Art

A vehicle has been proposed in which an engine and a motor are provided as driving power sources, the engine is connected to a torque converter including a lock-up clutch and a transmission via a first clutch, and the motor is connected to the torque converter via a second clutch (refer, for example, to Japanese Patent Application Publication No. JP-A-2000-103259). In such a vehicle, after the lock-up clutch is released, the driving power source is switched between the engine and the motor by releasing one of the first clutch and the second clutch, which has been applied, and applying the other of the first clutch and the second clutch, which has been released. Thus, torque fluctuations due to such switching between the two driving power sources is absorbed by the torque converter, and, therefore, a shock can be reduced.

Generally, in the above-mentioned vehicle, in addition to the torque fluctuations, a shock may occur, for example, when the lock-up clutch is released and when the connection provided by the clutch is terminated. Control of the lock-up clutch or the clutch is sometimes performed regardless of the intention of the driver, when the vehicle is decelerated, for example, when the brake pedal is depressed while the vehicle is running. If a shock occurs during such unintended control, the driver may feel a sense of discomfort.

### SUMMARY OF THE INVENTION

It is an object of the invention to provide a vehicle where a sense of discomfort felt by the driver can be suppressed, and a method for controlling such a vehicle.

A first aspect of the invention relates to a vehicle. The vehicle includes an internal combustion engine; shifting means for changing a speed ratio and transmitting the power transmitted from the output shaft of the internal combustion engine to the first axle based on the changed speed ratio; transmitting means including a lock-up clutch that can transmit the power transmitted from the output shaft of the internal combustion engine to the shifting means without a slip; connecting-disconnecting means for connecting-disconnecting the transmitting means and the shifting means to/from each other; and engine stop timing control means for performing release control for controlling the transmitting means and the connecting-disconnecting means such that the lock-up clutch is released and the transmitting means and the shifting means are disconnected from each other based on the operation performed by the driver if an instruction to stop the operation of the internal combustion engine is provided when the lock-up clutch of the transmitting means is applied and the transmitting means and the shifting means are connected to each other by the connecting-disconnecting means, and for controlling the internal combustion engine such that the operation of the internal combustion engine is stopped after the release control is performed.

With the above-mentioned configuration, the release control for controlling the transmitting means and the connecting-disconnecting means is performed such that the lock-up clutch is released and the transmitting means and the shifting means are disconnected from each other based on the operation performed by the driver if an instruction to stop the operation of the internal combustion engine is provided when the lock-up clutch of the transmitting means is applied and the transmitting means and the shifting means are connected to each other by the connecting-disconnecting means, and the internal combustion engine is controlled such that the operation of the internal combustion engine is stopped after the release control is performed. Because the lock-up clutch is released and the transmitting means and the shifting means are disconnected from each other based on the operation performed by the driver, a sense of discomfort felt by the driver can be suppressed.

In the above-mentioned release control, the engine stop timing control means may control the transmitting means and the connecting-disconnecting means such that the transmitting means and the shifting means are disconnected from each other after the lock-up clutch is released. Thus, transfer to a shock, which occurs due to termination of the connection between the transmitting means and the shifting means, to the internal combustion engine can be suppressed.

In the above-mentioned release control, the engine stop timing control means may control the transmitting means and the connecting-disconnecting means based on the brake operation performed by the driver. Thus, the control based on the brake operation performed by the driver can be performed. In this case, braking pressure detecting means for detecting a braking pressure that is a pressure at which the brake pedal is depressed may be provided. Also, in the release control, the engine stop timing control means may control the transmitting means and the connecting-disconnecting means based on the detected braking pressure. In the release control, when the transmitting means and the connecting-disconnecting means are controlled based on the braking pressure, the engine stop timing control means may control the transmitting means such that the lock-up clutch is gradually released if the detected braking pressure is lower than the first predetermined pressure, and such that the lock-up clutch is promptly released if the detected braking pressure is equal to or higher than the first predetermined pressure. If the detected braking pressure is lower than the first predetermined pressure, the transmitting means is controlled such that the lock-up clutch is gradually released. Accordingly, occurrence of a shock due to the release of the lock-up clutch can be suppressed, and, therefore, a sense of discomfort felt by the driver can be further suppressed. On the other hand, if the detected braking pressure is equal to or higher than the first predetermined value, the transmitting means is controlled such that the lock-up clutch is promptly released. Accordingly, the lock-up clutch can be promptly released. In addition, in the release control, when the transmitting means and the connecting-disconnecting means are controlled based on the braking pressure, the engine stop timing control means controls the connecting-disconnecting means such that the transmitting means and the shifting means are gradually disconnected from each other if the detected braking pressure is lower than the second predetermined pressure, and such that the transmitting means and the shifting means are promptly disconnected from each other if the detected braking pressure is equal to or higher than the second predetermined pressure. Because the connecting-disconnecting means is controlled such that the transmitting means and the shifting means are gradually disconnected from each other if the detected braking pressure is lower than the second predetermined pressure, occurrence of a shock due to termination of the connection between the transmitting means and the shifting means can be suppressed. As a result, a sense of discomfort felt by the drive can be further suppressed. Meanwhile, because the connecting-disconnecting means is controlled such that the transmitting means and the shifting means are promptly disconnected from each other if the detected braking pressure is equal to or higher than the second predetermined pressure, the transmitting means and the shifting means can be promptly disconnected from each other by the connecting-disconnecting means. The first predetermined pressure and the second predetermined pressure may be equal to each other. Alternatively, the first predetermined pressure and the second predetermined pressure may differ from each other.

In the vehicle according to the above-mentioned aspect of the invention, an electric motor that can output power to the above-mentioned first axle or another second axle, and drive control means for driving the electric motor based on the operation performed by the driver may be further provided. Also, in the vehicle according to the above-mentioned aspect of the invention, the transmitting means may be a torque converter, and the shifting means may be a continuously variable transmission.

A second aspect of the invention relates to a method for controlling a vehicle including an internal combustion engine; shifting means for changing a speed ratio and transmitting the power transmitted from the output shaft of the internal combustion engine to the first axle based on the changed speed ratio; transmitting means including a lock-up clutch that can transmit the power transmitted from the output shaft of the internal combustion engine to the shifting means without a slip; and connecting-disconnecting means for connecting-disconnecting the transmitting means and the shifting means to/from each other. According to the control method, release control for controlling the transmitting means and the connecting-disconnecting means is performed such that the lock-up clutch is released and the transmitting means and the shifting means are disconnected from each other based on the operation performed by the driver if an instruction to stop the operation of the internal combustion engine is provided when the lock-up clutch of the transmitting means is applied and the transmitting means and the shifting means are connected to each other by the connecting-disconnecting means, and the internal combustion engine is controlled such that the operation of the internal combustion engine is stopped after the release control is performed.

In the method for controlling a vehicle according to the above-mentioned aspect of the invention, the release control for controlling the transmitting means and the connecting-disconnecting means is performed such that the lock-up clutch is released and the transmitting means and the shifting means are disconnected from each other based on the operation performed by the driver if an instruction to stop the operation of the internal combustion engine is provided when the lock-up clutch of the transmitting means is applied and the transmitting means and the shifting means are connected to each other by the connecting-disconnecting means, and the internal combustion engine is controlled such that the operation of the internal combustion engine is stopped after the release control is performed. Because the lock-up clutch is released and the transmitting means and the shifting means are disconnected from each other based on the operation performed by the driver, a sense of discomfort felt by the driver can be suppressed.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 illustrates the configuration of a hybrid vehicle 20 according to an embodiment of the invention; and

FIG. 2 illustrates the flowchart showing an example of the clutch control routine performed by a CVTECU 59 according to the embodiment.

### DETAILED DESCRIPTION OF THE EXAMPLE EMBODIMENTS

Next, an example embodiment of the invention will be described with reference to accompanying drawings.

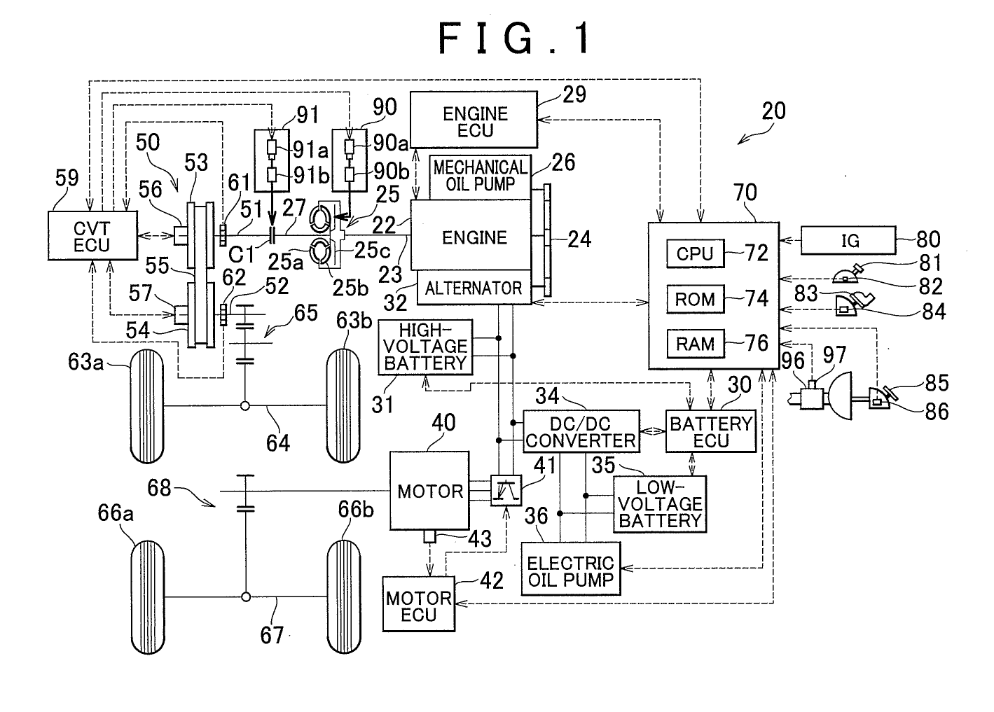

FIG. 1 illustrates the configuration of a hybrid vehicle 20 according to an embodiment of the invention. The hybrid vehicle 20 according to the embodiment is a four-wheel-drive vehicle that can run by driving four wheels. The hybrid vehicle 20 includes a front wheel drive system that drives front wheels 63a and 63b by transmitting the power from an engine 22 to a front axle 64 via a torque converter 25, a CVT 50, and a gear mechanism 65; a rear wheel drive system that drives rear wheels 66a and 66b by transmitting the power from a motor 40 to a rear axle 67 via a gear mechanism 68; and an electronic control unit for a hybrid vehicle (hereinafter, referred to as a “hybrid ECU”) 70 that controls the entire hybrid vehicle 20. The hybrid vehicle 20 further includes a mechanical oil pump 26 that generates line pressure for the CVT 50, the torque converter 25, and a clutch C1 by using the power from the engine 22; and an electric oil pump 36 that generates the line pressure by using the electric power supplied from an alternator 32 via a DC/DC converter 34. The alternator 32 generates electric power by using the power from the engine 22. The electric oil pump 36 includes an electric motor (not shown) that is controlled by the hybrid ECU 70.

The engine 22 is an internal combustion engine that outputs power by burning hydrocarbon fuel, for example, gasoline or diesel oil. The alternator 32 and the mechanical oil pump 26 are connected to a crankshaft 23 of the engine 22 by a belt 24. An electronic control unit for an engine (hereinafter, referred to as an “engine ECU”) 29 performs the operation control of the engine 22 such as the fuel injection control, the ignition control, and the intake air amount control. The engine ECU 29 communicates with the hybrid ECU 70. The engine ECU 29 controls the operation of the engine 22 based on the control signal from the hybrid ECU 70, and outputs the data concerning the operating state of the engine 22 to the hybrid ECU 70 when required.

The motor 40 is formed of a known synchronous generator motor that can serve as an electric power generator and that can also serve as an electric motor. The motor 40 is supplied with electric power from a high voltage battery 31 via an inverter 41, and is supplied with electric power from the alternator 32. The motor 40 is controlled by an electronic control unit for a motor (hereinafter, referred to as a “motor ECU”) 42. The motor ECU 42 receives the signals necessary for controlling driving of the motor 40 such as a signal from a rotational position detecting sensor 43 that detects the rotational position of the rotor of the motor 40 and a signal indicating the phase current applied to the motor 42, which is detected by a current sensor (not shown). The motor ECU 42 communicates with the hybrid ECU 70. The motor ECU 42 controls driving of the motor 40 by outputting a switching control signal to the inverter 41 based on the control signal from the hybrid ECU 70, and outputs the data concerning the operating state of the motor 40 to the hybrid ECU 70 when required.

The high voltage battery 31 is formed of a secondary battery with a rated voltage of Vh (for example, 42 [V]). The high voltage battery 31 stores the electric power supplied from the alternator 32, and supplies the electric power to the motor 40. A low voltage battery 35 is formed of a secondary battery with a rated voltage V1 that is lower than the rated voltage of Vh (for example, approximately 12 [V]). The low voltage battery 35 stores the electric power supplied from the alternator 32 via the DC/DC converter 34, and supplies the electric power to the elements such auxiliaries (not shown) that operate at a low voltage. The DC/DC converter 34 is formed of a commonly used DC/DC converter that converts direct-current electric power into direct-current electric power having a different voltage. The DC/DC converter 34 converts the electric power generated by the alternator 32 to the electric power having a lower voltage, and supplies the electric power to the low voltage battery 35 and the electric motor (not shown) of the electric oil pump 36. The high voltage battery 31, the low voltage battery 35 and the DC/DC converter 34 are managed by an electronic control unit for a battery (hereinafter, referred to as a “battery ECU”) 30. The battery ECU 30 receives the signals necessary for managing the high voltage battery 31 and the low voltage battery 35, for example, the signals indicating the voltage of each of the high voltage battery 31 and the low voltage battery 35, a charging current and a discharging current, and the temperature of the battery, which are detected by sensors (not shown). The battery ECU 30 outputs the data concerning the states of the high voltage battery 31 and the low voltage battery 35 to the hybrid ECU 70 via data communication, when required. The battery ECU 30 also calculates the state of charge (SOC) based on the integral value of the charging current and the discharging current to manage the high voltage battery 31 and the low voltage battery 35.

The CVT 50 includes a primary pulley 53 in which the groove width can be changed and which is connected to an input shaft 51; a secondary pulley 54 in which the groove width can be changed and which is connected to an output shaft 52 serving as the drive shaft; a belt 55 that is looped over the grooves of the primary pulley 53 and the secondary pulley 54; a first actuator 56 that changes the groove width of the primary pulley 53; and a second actuator 57 that changes the groove width of the secondary pulley 54. The CVT 50 continuously changes the ratio between rotational speed of the input shaft 51 and the rotational speed of an output shaft 52 by changing the groove widths of the primary pulley 53 and the secondary pulley 54 by using the first actuator 56 and the second actuator 57, respectively. Here, the first actuator 56 is formed of a hydraulic actuator that is used for controlling the speed ratio, and the second actuator 57 is formed of a hydraulic actuator that is used for controlling the force for holding the belt 55 for adjusting the capacity of toque that the CVT 50 can transmit.

An electronic control unit for a CVT (hereinafter, referred to as a “CVTECU”) 59 controls the speed ratio and the belt holding force of the CVT 50. The CVTECU 59 is formed of a microprocessor mainly including a CPU (not shown). In addition to the CPU, the CVTECU 59 includes ROM (not shown) that stores processing programs; RAM (not shown) that temporarily stores data; an input port (not shown); an output port (not shown); and a communication port (not shown). The CVTECU 59 receives a rotational speed Np of the input shaft 51, which is transmitted from a rotational speed sensor 61 connected to the input shaft 51, and a rotational speed Ns of an output shaft 52, which is transmitted from a rotational speed sensor 62 connected to the output shaft 52. The CVTECU 59 outputs the drive signals to the first actuator 56 and the second actuator 57. The CVTECU 59 communicates with the hybrid ECU 70. The CVTEUC 59 controls the speed ratio of the CVT 50 based on the control signal from the hybrid ECU 70, and outputs the data concerning the operating state of the CVT 50 such as the rotational speed Np of the input shaft 51, which is transmitted from the rotational speed sensor 61, and the rotational speed Ns of the output shaft 52, which is transmitted from the rotational speed sensor 62, to the hybrid ECU 70 when required. The CVTECU 50 controls establishment/termination of the connection provided by the clutch C1 and application/release of a lock-up clutch 25c of the torque converter 25, and stores the state of establishment/termination of the connection provided by the clutch C1 and the state of application/release of the lock-up clutch 25c.

The torque converter 25 is formed of a known hydraulic torque converter including a lock-up clutch. The torque converter 25 includes a pump impeller 25a connected to the crankshaft 23 of the engine 22 and a turbine runner 25b connected to the input shaft 51 of the CVT 50. The torque converter 25 connects the pump impeller 25a to the turbine runner 25b by using the lock-up clutch 25c when required. The lock-up clutch 25c is controlled based on the hydraulic pressure supplied from a hydraulic circuit 90 including a lock-up solenoid 90a and a lock-up control valve 90b. The hydraulic circuit 90 controls the opening amount of the lock-up control valve 90b, which allows the line pressure supplied from the mechanical oil pump 26 and the electric oil pump 36 to be transmitted to the lock-up clutch 25c, by adjusting the duty ratio of the lock-up solenoid 90a, thereby applying/releasing the lock-up clutch 25c and the controlling the force for applying the lock-up clutch 25c.

The clutch C1 connects/disconnects the output shaft 27 of the torque converter 25 and the input shaft 51 of the CVT 50 to/from each other. The clutch C1 is controlled based on the hydraulic pressure supplied from a hydraulic circuit 91 including a linear solenoid 91a and a control valve 91b for a clutch (hereinafter, referred to as a “clutch control valve 91b”). The hydraulic circuit 91 controls the opening amount of the clutch control valve 91b, which allows the line pressure supplied from the mechanical oil pump 26 and the electric oil pump 36 to be transmitted to the clutch C1, by adjusting the duty ratio of the linear solenoid 91a, thereby applying/releasing the clutch C1 and the force for applying the clutch C1.

The hybrid ECU 70 is formed of a microprocessor mainly including a CPU 72. In addition to the CPU 72, the hybrid ECU 70 includes ROM 74 that stores processing programs, RAM 76 that temporarily stores data; an input port (not shown); an output port (not shown); and a communication port (not shown). The hybrid ECU 70 receives, via the input port, an ignition signal from an ignition switch 80, a signal indicating a shift position SP transmitted from a shift position sensor 82 that detects the position of a shift lever 81, a signal indicating an accelerator pedal operation amount Acc transmitted from an accelerator pedal position sensor 84 that detects the operation amount of an accelerator pedal 83, a signal indicating a brake pedal position BP transmitted from a brake pedal position sensor 86 that detects the operation amount of a brake pedal 85, a signal indicating a master cylinder pressure Pm transmitted from a master cylinder pressure sensor 97 that detects the master cylinder pressure of a brake master cylinder 96 that generates a hydraulic pressure (master cylinder pressure ) in the brake oil based on the operation of the braked pedal 85 performed by the driver, and the like. The hybrid ECU 70 outputs control signals to the alternator 32 and the like via the output port. Also, the hybrid ECU 70 exchanges the various control signals and the data with the engine ECU 29, the battery ECU 30, the motor ECU 42, and the CVTECU 59.

The thus configured hybrid vehicle 20 according to the embodiment runs by mainly transmitting the power from the engine 22 to the front wheels based on the operation of the accelerator pedal performed by the driver, and runs by transmitting the power from the motor 40 to the rear wheels when required. The vehicle runs by driving the four wheels, for example, when the vehicle is rapidly accelerated because the accelerator pedal 83 is depressed by a large amount or when the wheel skids. When the vehicle is decelerated, for example, when the brake pedal 85 is depressed while the vehicle is running, the engine 22 is stopped while the disconnection provided by the clutch C1 is terminated and the engine 22 is disconnected from the CVT 50, and the regenerative control of the motor 40 is performed. Then, braking force is applied to the rear wheels 66a and 66b by using the regenerative braking by the motor 40, and the electric power regenerated by the motor 40 is stored in the high-voltage battery 31, whereby the efficiency of the entire system is improved.

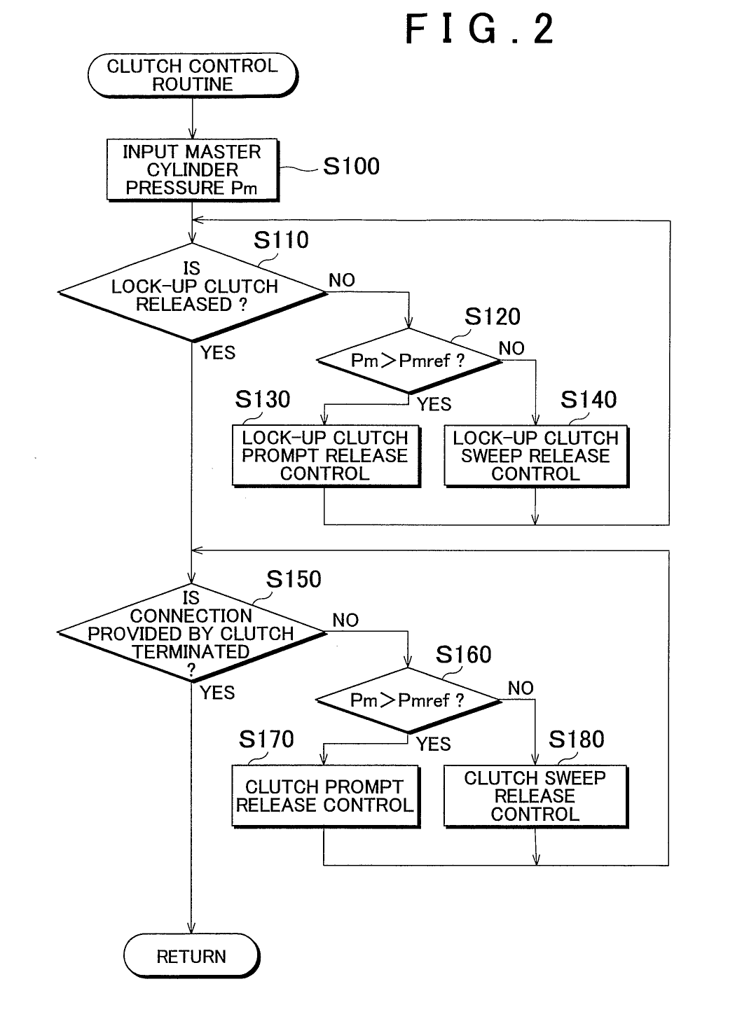

Next, the operation of the thus configured hybrid vehicle 20 according to the embodiment will be described. Particularly, the operation that is performed when the lock-up clutch 25c is released and connection provided by the clutch C1 is terminated before the operation of the engine 22 is stopped will be described. FIG. 2 illustrates the flowchart showing an example of the clutch control routine performed by the CVTECU 59 according to the embodiment.

In this routine, in step S100, the CVTECU 59 performs the process for inputting the data such as the master cylinder pressure Pm of the master cylinder 96, which is necessary for the control. In this case, the master cylinder pressure Pm detected by the master cylinder pressure sensor 97, which is transmitted from the hybrid ECU 70, is input in the CVTECU 59.

After the master cylinder pressure Pm is input in the CVTECU 59, the CVTECU 59 determines in step S110 whether the lock-up clutch 25c is released. If the lock-up clutch 25c is not released, the CVTECU 59 determines in step S120 whether the input master cylinder pressure Pm is higher than a reference pressure Pmref that is used as the threshold value at which it is estimated that the driver requests prompt braking by depressing the brake pedal 85. If the master cylinder pressure Pm is higher than the reference pressure Pmref, the CVTECU 59 determines that the driver requests prompt braking, and performs the lock-up clutch prompt release control for promptly releasing the lock-up clutch 25c by promptly (for example, in approximately several milliseconds) increasing the duty ratio of the lock-up solenoid 90a from a value equal to or close to 100% to a value equal to or close to 0%, in step S130. Then, the CVTECU 59 performs step S110 again. As described so far, when the driver has depressed the brake pedal 85, the lock-up clutch 25c can be promptly released.

On the other hand, if the master cylinder pressure Pm is lower than the reference pressure Pmref, the CVTECU 59 determines that the driver has not depressed the brake pedal 85 or the driver has depressed the brake pedal 85 by a considerably small amount, and, therefore, the drive does not request prompt braking. Accordingly, the CVTECU 59 performs the lock-up clutch sweep release control for gradually releasing the lock-up clutch 25c by gradually (for example, in approximately several hundreds of milliseconds) decreasing the duty ratio of the lick-up solenoid 90a from a value equal to or close to 100% to a value equal to or close to 0%, in step S140. Then, the CVTECU 59 performs step S110 again. When the driver has not depressed the brake pedal 85 or the driver has depressed the brake pedal 85 by a considerably small amount, the lock-up clutch 25c is gradually released. Thus, occurrence of a shock due to release of the lock-up clutch 25c can be suppressed.

If it is determined in step S110 that the lock-up clutch 25c is released, the CVTECU 50 determines in step S150 whether the connection between the output shaft 27 of the torque converter 25 and the input shaft 51 of the CVT 50 provided by the clutch C1 is terminated. If the connection provided by the clutch C1 is not terminated, the CVTECU 59 determines in step S160 whether the input master cylinder pressure Pm is higher than the reference pressure Pmref. If the master cylinder pressure Pm is higher than the reference pressure Pmref, the CVTECU 59 determines that the driver requests prompt braking by depressing the brake pedal 85. Then, the CVTECU 59 performs the clutch prompt release control for promptly terminating the connection provided by the clutch C1 by promptly (for example, in approximately several milliseconds) decreasing the duty ratio of the linear solenoid 91 a from a value equal to or close to 100% to a value equal to or close to 0%, in step S170. Then, the CVTECU 59 performs step S150 again. As described so far, when the driver has depressed the brake pedal 85, the connection provided by the clutch C1 can be promptly terminated.

On the other hand, if the master cylinder pressure Pm is lower than the reference pressure Pmref, the CVTECU 59 performs the clutch sweep release control for gradually terminating the connection provided by the clutch C1 by gradually (for example, in approximately several hundreds of milliseconds) decreasing the duty ratio of the linear solenoid 91 from a value equal to or close to 100% to a value equal to or close to 0%, in step S180. Then, the CVTECU 59 performs step S150 again. As described so far, when the driver has not depressed the brake pedal 85 or the driver has depressed the brake pedal 85 by a considerably small amount, the connection provided by the clutch C1 is gradually terminated. Thus, occurrence of a shock due to termination of the connection provided by the clutch C1 can be suppressed.

With the above-mentioned hybrid vehicle 20 according to the embodiment, when the driver has depressed the brake pedal 85, the lock-up clutch 25c is promptly released, and the connection between the output shaft 27 of the torque converter 25 and the input shaft 51 of the CVT 50 provided by the clutch C1 is promptly terminated. On the other hand, when the driver has not depressed the brake pedal 85 or the driver has depressed the brake pedal 85 by a considerably small amount, the lock-up clutch 25c is gradually released, and the connection between the output shaft 27 of the torque converter 25 and the input shaft 51 of the CVT 50 provided by the clutch C1 is gradually terminated. Because the lock-up clutch 25c is released and the connection provided by the clutch C1 is terminated based on the degree to which the driver has depressed the brake pedal 85, a sense of discomfort felt by the driver can be suppressed. Also, because the connection provided by the clutch C1 is terminated after the lock-up clutch 25 is released, the torque fluctuations due to the termination of the connection provided by the clutch C1 can be absorbed by the fluid of the torque converter 25, and, therefore, a shock can be reduced.

In the hybrid vehicle 20 according to the embodiment, it is determined in step S160 whether the master cylinder pressure Pm of the brake master cylinder 96 is higher than the reference pressure Pmref by using the same reference pressure Pmref as that used in step 120. However, the master cylinder pressure may be compared with the reference pressure that differs from the reference pressure Pmref used in step S120.

In the hybrid vehicle 20 according to the embodiment, application/release of the lock-up clutch 25c and establishment/termination of the connection provided by the clutch C1 are controlled based on the master cylinder pressure Pm of the brake master cylinder 96. However, application/release of the lock-up clutch 25c and establishment/termination of the connection provided by the clutch C1 may be controlled based on another parameter that indicates the operation performed by the driver. For example, the control may be performed based on another parameter indicating the operating state of the brake pedal 85 such as the brake pedal position BP transmitted from the brake pedal position sensor 86 that detects the operation amount of the brake pedal 85 or the operating state of the element other than the brake pedal 85 such as the accelerator pedal operation amount Acc transmitted from the accelerator pedal position sensor 84 that detects the operation amount of the accelerator pedal 83.

In the hybrid vehicle 20 according to the embodiment, the connection provided by the clutch C1 is terminated after the lock-up clutch 25c is released. However, the lock-up clutch 25 may be released after connection provided by the clutch C1 is terminated.

In the hybrid vehicle 20 according to the embodiment, the power of the motor 40 is transmitted to the rear axle 67. However, the power of the motor 40 may be transmitted to the front axle 64.

While the invention has been described with reference to the preferred embodiment thereof, it is to be understood that the invention is not limited to the preferred embodiment. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

1-14. (canceled)

15. A vehicle, comprising:
an internal combustion engine;
a shifting device that changes a speed ratio and transmits power transmitted from an output shaft of the internal combustion engine to a first axle based on the changed speed ratio;
a transmitting device that includes a lock-up clutch which can transmit the power transmitted from the output shaft of the internal combustion engine to the shifting device without a slip;
a connecting-disconnecting device that connects the transmitting device and the shifting device to each other, and that disconnects the transmitting device and the shifting device from each other;
an engine stop timing control device that performs release control for controlling the transmitting device and the connecting-disconnecting device such that the lock-up clutch is released and the transmitting device and the shifting device are disconnected from each other based on an operation performed by a driver if an instruction to stop an operation of the internal combustion engine is provided when the lock-up clutch of the transmitting device is applied and the transmitting device and the shifting device are connected to each other by the connecting-disconnecting device, and that controls the internal combustion engine such that the operation of the internal combustion engine is stopped after the release control is performed; and
a braking pressure detecting device that detects a braking pressure as the state of the brake operation, wherein:
the engine stop timing control device controls the transmitting device and the connecting-disconnecting device based on a state of a brake operation performed by the driver;
the engine stop timing control device controls the transmitting device and the connecting-disconnecting device based on the detected braking pressure; and
the engine stop timing control device controls the transmitting device such that the lock-up clutch is gradually released if the detected braking pressure is lower than a first predetermined pressure, and such that the lock-up clutch is promptly released if the detected braking pressure is equal to or higher than the first predetermined pressure.

16. The vehicle according to claim 15, wherein the engine stop timing control device controls the transmitting device and the connecting-disconnecting device such that the transmitting device and the shifting device are disconnected from each other after the lock-up clutch is released.

17. The vehicle according to claim 15, wherein the engine stop timing control device controls the connecting-disconnecting device such that the transmitting device and the shifting device are gradually disconnected from each other if the detected braking pressure is lower than a first predetermined pressure, and such that the transmitting device and the shifting device are promptly disconnected from each other if the detected braking pressure is equal to or higher than the first predetermined pressure.

18. The vehicle according to claim 15, wherein the engine stop timing control device controls the connecting-disconnecting device such that the transmitting device and the shifting device are gradually disconnected from each other if the detected braking pressure is lower than a second predetermined pressure, and such that the transmitting device and the shifting device are promptly disconnected from each other if the detected braking pressure is equal to or higher than the second predetermined pressure.

19. The vehicle according to claim 15, further comprising:
an electric motor that outputs power to the first axle or a second axle that differs from the first axle; and
a drive control device that drives the electric motor based on an operation performed by the driver.

20. The vehicle according to claim 15, wherein the transmitting device of the vehicle is a toque converter, and the shifting device of the vehicle is a continuously variable transmission.

21. A method for controlling a vehicle including an internal combustion engine; a shifting device that changes a speed ratio and transmits power transmitted from an output shaft of the internal combustion engine to a first axle based on the changed speed ratio; a transmitting device that includes a lock-up clutch that can transmit the power transmitted from the output shaft of the internal combustion engine to the shifting device without a slip; a connecting-disconnecting device that connects the transmitting device and the shifting device to each other, and that disconnects the transmitting device and the shifting device from each other; and a braking pressure detecting device that detects a braking pressure as the state of the brake operation, the method comprising:
performing release control for controlling the transmitting device and the connecting-disconnecting device such that the lock-up clutch is released and the transmitting device and the shifting device are disconnected from each other based on an operation performed by a driver if an instruction to stop an operation of the internal combustion engine is provided when the lock-up clutch of the transmitting device is applied and the transmitting device and the shifting device are connected to each other by the connecting-disconnecting device; and
controlling the internal combustion engine such that the operation of the internal combustion engine is stopped after the release control is performed, wherein:
the transmitting device and the connecting-disconnecting device are controlled based on a state of a brake operation performed by the driver;
the transmitting device and the connecting-disconnecting device are controlled based on the detected braking pressure; and
the transmitting device is controlled such that the lock-up clutch is gradually released if the detected braking pressure is lower than a first predetermined pressure, and such that the lock-up clutch is promptly released if the detected braking pressure is equal to or higher than the first predetermined pressure.
